(19) United States
(12) Patent Application Publication
(10) Pub. No.: US 2003/0015641 A1
(43) Pub. Date: Jan. 23, 2003

(54) Telescopic boom for use in model building

(76) Inventor: Gunther Conrad, Igensdorf (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/197,076

(22) Filed: Jul. 16, 2002

(30) Foreign Application Priority Data
Jul. 19, 2001 (DE) 201 11 958.7

(51) Int. Cl. A47F 5/00; F16M 13/00; E04G 25/00

(52) U.S. Cl. 248/354.5; 248/188.5; 248/408

(57) ABSTRACT

A model of a telescopic boom including at least three tubular sections arranged in a row one after another and an outer cross-section of which becomes smaller from a tubular section to a tubular section in a direction toward a free end of the telescopic boom, with each of the tubular sections forming, at its front end, a cut-out into which a bar provided at a rear end of a preceding, in the direction toward the free end of the telescopic boom, tubular section, projects in a pull-out condition of the telescopic boom, with the front bar surface of a bar projecting, in the pull-out condition of the boom, beyond the cut-out, and with the rear abutment edge of the cut-out facing the rear surface of the bar.

### BACKGROUND OF THE INVENTION

1. Field of the Invention

The present invention relates to a field of model building and, in particular, to a model of a telescopic boom including at least three tubular sections arranged in a row one after another and an outer cross-section of which becomes smaller from a tubular section to a tubular section in a direction toward a free end of the telescopic boom, with the tubular sections being telescopically pushed pairwise into each other by displacing the tubular sections relative to each other, whereby the tubular sections are pushed together and are pulled out of each other, with each of the tubular sections forming, at its front end, a cut-out into which a bar, which is provided at a rear end of a preceding, in the direction toward the free end of the telescopic boom tubular section, projects in a pull-out condition of the telescopic boom, and with the bar forming, at its side facing in the direction toward the free end of the telescopic boom, a front bar surface that cooperates with a front, in the direction toward the free end of the telescopic boom, front abutment edge of the cut-out, forming opposite the front bar surface, a rear bar surface that cooperates with a rear abutment edge of the cut-out provided opposite the front abutment edge, and forming an end slope descending from the front bar surface toward the rear bar surface.

2. Description of the Prior Art

In the field of miniature model building, there exist miniature model apparatuses or machines such as, e.g., a self-propelled crane model equipped with a telescopic boom. The tubular section of the telescopic boom, which has a large cross-section, has an inner or rear end mounted on a model apparatus or machine. The free end of the telescopic boom is usually equipped with a device associated with the function of the machine or apparatus. The telescopic boom is assembled manually by pushing the tubular sections, which form the boom, together until respective flanges, ledges and the like abut each other. The telescopic boom is also extended manually by the tubular sections being pulled out until the locking bars provided on the tubular sections perform their predetermined function. During the tubular sections being pulled out, a bar of an inner tubular section becomes engaged in a cut-out formed in the immediately adjacent, preceding, in the direction toward the boom free end, outer tubular section, with the front bar surface engaging the front abutment edge of the cut-out of the outer tubular section.

In a conventional telescopic boom, the size of the front bar surface is limited to the cut-out, with the bar having an end slope extending toward the rear abutment edge of the cut-out and located inwardly of the rear abutment edge. Upon the two adjacent tubular sections being pushed together, the front region of the outer larger tubular section does not act on the bar of the inner smaller tubular section that precedes, in the direction toward the free end of the boom, the inner tubular section that cooperates with the larger tubular section. Rather, with the two tubular sections being pushed together, the bar is pushed or pressed out of the cut-out by the lower or rear abutment edge of the cut-out acting on the end slope of the bar. As a result, each time a pressure is applied to the free end of the boom, the tubular sections are pushed together as each bar is pushed into the cut-out as a result of the action of the respective rear abutment edge thereon. This uncontrollable telescoping of the tubular sections is a serious drawback, as it can inadvertently lead to the collapse of the boom.

Accordingly, an object of the present invention is to provide a model of a telescopic boom of the type described above in which the pushing together of the respective tubular sections can be controlled by engagement of a bar in a cut-out.

### SUMMARY OF THE INVENTION

This and other objects of the present invention, which will become apparent hereinafter, are achieved by providing a bar with which in the pull-out condition of the telescopic boom, the front bar surface of a respective bar projects beyond a cut-out of respective tubular section, with the rear abutment edge of the cut-out being located against the rear bar surface, and in which each of the tubular sections has a front region whereby upon two adjacent tubular sections being pushed together, the front region of a larger outer tube presses the bar of a smaller tubular section, which precedes the inner tubular section that cooperates with the larger outer tubular section, into the cut-out so that the rear bar surface moves inwardly away from the rear abutment edge of the cutout.

When the inventive telescopic boom is completely extended, its collapsing, as a result of pressure applied to the free end, is prevented by the engagement of the rear bar surface of each of the bar with the rear abutment edge of a respective cut-out. A bar can be pushed into a cutout only manually so that the rear abutment edge would engage the end slope of the bar. Only after this, the two adjacent inner and outer tubular sections can be pushed together. When the front region of the outer tubular section finds itself at the cut-out of the inner tubular section, it acts on the bar of the next tubular section, which is received in the cut-out of the first inner tubular section. The front region of the other tubular sections pushes the bar of the next smaller tubular section into the cut-out of the first inner tubular section. Thereby, the next smaller tubular section is pushed together with a first smaller tubular section that forms an outer tubular section with respect to the next smaller tubular section. Thereby, the pushing together of the tubular sections can be manually controlled by pushing a bar which projects outwardly from a cut-out inward into the cut-out.

It is particularly preferable and advantageous when each of the tubular sections except a rearmost section has a support for supporting the bar and having a shoulder engaging a wall of a respective tubular section in a region of an opening through which the bar extends, and when a radial extent of the bar over the shoulder exceeds in two times the wall thickness. In this case, the bar is supported by the shoulder, projecting through the guide opening in the inner tubular section and the cut-out of the outer tubular section. It is further preferable and advantageous when a dimension of the projection of the bar and a dimension of the rear bar surface in the same direction are substantially the same.

It is further preferable and advantageous when a larger outer tubular section of two adjacent tubular sections has, at its free end, an inner edge that, upon the two tubular sections being pushed together, runs up the bar of the next smaller tubular section.

As a rule, the telescopic boom is formed of more than three tubular sections, e.g., of four or five. As a rule, these tubular sections have a non-circular cross-section, so that two tubular section, when pushed together do not rotate relative to each other.

Advantageously, the-bar is supported on a support which is supported on a pin which is received in a slide and is biased toward the wall of the tubular section by a spring supported at its opposite ends against the support and the slide. The slide projects into an opening formed in the wall of the tubular section opposite the support and is supported against an inner wall of the outer tubular section that surrounds the inner tubular section.

The novel features of the present invention, which are considered as characteristic for the invention, are set forth in the appended claims. The invention itself, however, both as to its construction its mode of operation, together with additional advantages and objects thereof, with be best understood from the following detailed description of the preferred embodiment, when read with reference to the accompanying drawings.

### BRIEF DESCRIPTION OF THE DRAWINGS:

The drawings show:

FIG. 1. a plan view of a telescopic boom model according to the present invention;

FIG. 2. a cross-sectional view a long line 2-2 in FIG. 1 at an increased, in comparison with FIG. 1, scale; and

FIG. 3. a cross-sectional view along line 3-3 in FIG. 2.

### DETAILED DESCRIPTION OF THE PREFERRED EMBODIMENT

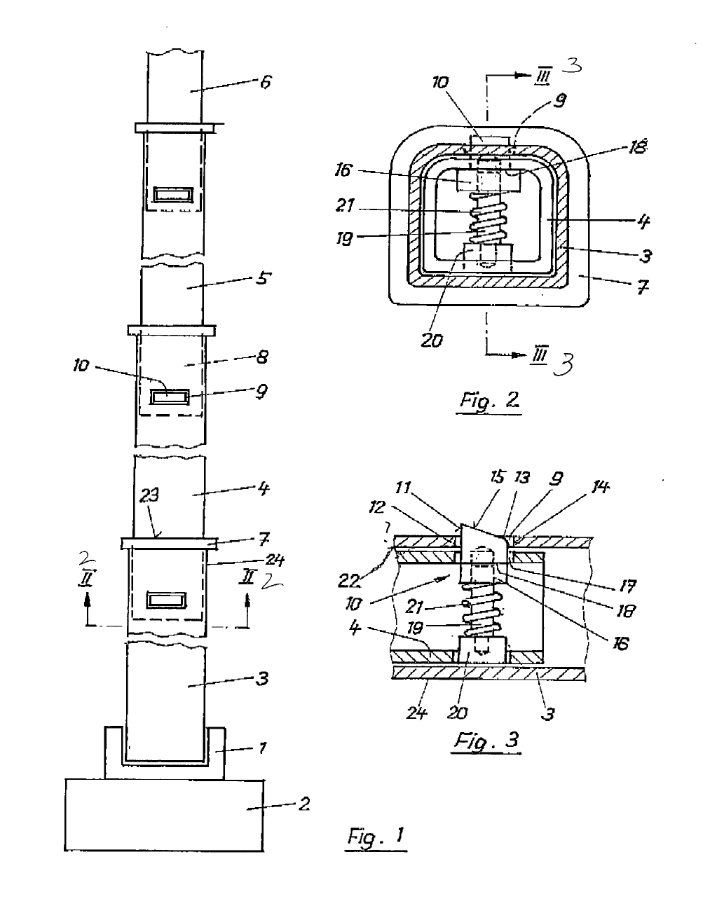

A telescopic boom for use in model building according to the present invention, which is shown in FIG. 1, is supported in a holding device 1 mounted on miniature model machine 2. At its opposite end, the telescopic boom has an appropriate end section (not shown). Only four tubular sections 3, 4, 5, 6 of the telescopic boom are shown in FIG. 1. The tubular sections 3, 4, 5, 6 are shown in their pull-out conditions. The first tubular section 3 is supported in the holding device 1 at one of its ends. At its opposite end, the tubular section 3 has a flange or ledge 7. The second tubular section 4 and the following tubular sections 5, 6 project into each other in their pull-out condition, with their respective rear regions extending into respective preceding tubular sections. In their telescopic condition (not shown), the ledges 7 of all of the tubular sections tightly abut each other. Except the foremost tubular section, which is not shown, all of the tubular sections 3, 4, 5, 6 form, at their front end region, a break-or cut-out 9 which is spaced from the front-end surface of the respective tubular section by a distance somewhat smaller than the length of the rear region 8. Except the rearmost tubular section 3, each of the tubular sections 4, 5, 6 is provided, in their respective rear regions 8, with a bar 10 that projects into the cut-out 9 of the preceding tubular section in the pull-out condition of the tubular sections.

The bar 10 forms a front bar surface 11 that extends perpendicular to the central axis of the tubular section and cooperates with a front abutment edge 12 of the cut-out 9. As shown in FIG. 3, the front bar surface 11 slightly extends beyond the abutment edge 12 of the cut-out 9. The bar 10 further forms a rear bar surface 13 which likewise extends perpendicular to the central axis of the tubular section and cooperates with a rear abutment edge 14 of the cut-out 9. The rear bar surface 13 does not extend beyond the rear abutment edge 14, as it can be seen in FIG. 3. At its end, the bar 10 has an end slope 15 that is inclined from the front bar surface 11 toward the central axis of the tubular section. Each of the tubular section, except the foremost section, forms a front tubular region that, with the tubular section being pushed toward the cut-out 9 of the first preceding tubular section 4, extends, thereby, to the bar 10 of the second preceding section 5. The tubular region 10 pushes the bar 10 of the second preceding tubular section 5 back so far that the rear bar surface 13 releases the rear abutment edge 14. Only the first preceding tubular section 4 can further push back the bar 10 of the second preceding tubular section 5 over its end slope 15, with the second preceding section 5 being pushed together with its bar 10.

The bar 10 is supported on a support 16 which is provided in the associated tubular section 4, with the bar 10 projecting through the guide opening 17 formed in a wall of the tubular section 4. The support 16 engages the wall of the tubular section 4 with its shoulder 18. The support 16 is supported on a pin 19 which is received in a slide 20, and is biased toward the wall of the tubular section 4 by a spring 21 supported at its opposite end against the support 16 and the slide 20. The slide 20 project into an opening formed in the wall of the tubular section opposite the support 16 and is supported against an inner wall of the outer tubular section 3 that surrounds the tubular section 4. The larger tubular section 3 forms at its front end surface, an inner tubular edge 22.

Though the present invention was shown and described with references to the preferred embodiment, such is merely illustrative of the present invention and is not to be construed as a limitation thereof, and various modifications to the present invention will be apparent to those skilled in the art. It is, therefore, not intended that the present invention be limited to the disclosed embodiment or details thereof, and the present invention includes all of variations and/or alternative embodiments within the spirit and scope of the present invention as defined by the appended claims.

What is claimed is:

1. A model of a telescopic boom, comprising at least three tubular sections arranged in a row one after another and an outer cross-section of which becomes smaller from a tubular section to a tubular section in a direction toward a free end of the telescopic boom, with the tubular sections being telescopically pushed pairwise into each other by displacing the tubular sections relative to each other, whereby the tubular sections are pushed together and are pulled out of each other,
wherein each of the tubular sections forms, at a front end thereof, a cutout-into which a bar, which is provided at a rear end of a preceding, in the direction toward the free end of the telescopic boom, tubular section, projects in a pull-out condition of the telescopic boom,
wherein the bar forms, at a side thereof facing in the direction toward the free end of the telescopic boom, a front bar surface that cooperates with a front, in the direction toward the free end of the telescopic boom, front abutment edge of the cut-out, forms, opposite the front bar surface, a rear bar surface that cooperates with a rear abutment edge of the cut-out provided opposite the front abutment edge, and forms an end slope descending from the front bar surface toward the rear bar surface,
wherein, in the pull-out condition of the telescopic boom, the front bar surface of a respective bar projects beyond a cut-out of respective tubular section, with the rear abutment edge of the cut-out being located against the rear bar surface, and
wherein each of the tubular sections has a front region, whereby upon two adjacent tubular sections being pushed together, the front region of a larger outer tube presses the bar of a smaller tubular section preceding the adjacent smaller tubular section into the cut-out so that the rear bar surface moves away from the rear abutment edge of the cut-out.

2. A model of a telescopic boom asset forth in claim 1, wherein each of the tubular sections except a rearmost section has a support for supporting the bar and having a shoulder engaging a wall of a respective tubular section in a region of an opening through which the bar extends, and wherein a radial extent of the bar over the shoulder exceeds in two times a thickness of the wall.

3. A model of a telescopic boom as set forth in claim 1, wherein a dimension of a projection of the bar and a dimension of the rear bar surface in the same direction are substantially equal.

4. A model of a telescopic boom asset forth in claim 1, where in a larger outer tubular section of the two adjacent tubular sections has, at a free end thereof facing in the direction toward the free end of the telescopic boom, an inner edge that upon pushing the two adjacent tubular sections together, runs up the bar of the preceding smaller inner tubular section.
